(19) United States
(12) Patent Application Publication
(10) Pub. No.: US 2025/0262645 A1
(43) Pub. Date: Aug. 21, 2025

(54) UNMANNED WAREHOUSE-GOODS SORTING OPERATION DEVICE

(71) Applicant: HANGZHOU CITY UNIVERSITY, Hangzhou (CN)

(72) Inventors: Fang WANG, Hangzhou (CN); Chuang XU, Hangzhou (CN)

(21) Appl. No.: 19/193,528

(22) Filed: Apr. 29, 2025

(30) Foreign Application Priority Data
Oct. 28, 2024 (CN) 202411507701.4

(51) Int. Cl. B07C 3/08; B65G 43/08; B65G 47/49; B65G 47/96

(52) U.S. Cl. CPC B07C 3/08; B65G 43/08; B65G 47/49; B65G 47/962

(57) ABSTRACT

An unmanned warehouse-goods sorting operation device is provided, and includes a goods feeding conveyor, a tiltable tray assembly, and a goods discharging conveyor which are arranged in sequence in a longitudinal direction. The tiltable tray assembly is configured to perform bidirectional sorting on goods in a lateral direction. The tiltable tray assembly includes a tiltable tray part, load-bearing shaft rods, and a support frame.

### CROSS-REFERENCE TO RELATED APPLICATION

This application claims the priority of Chinese Patent Application No. 202411507701.4, entitled “Unmanned warehouse-goods sorting operation device”, filed with the Chinese Patent National Intellectual Property Administration on Oct. 28, 2024, which is incorporated herein by reference in its entirety as part of the present application.

### TECHNICAL FIELD

The present disclosure belongs to the technical field of sorting devices, and in particular, to an unmanned warehouse-goods sorting operation device.

### BACKGROUND

Unmanned warehouse-goods sorter is a process of using an automation technology and equipment to classify and organize goods in a warehouse. An entire sorting system is mainly composed of an identification system, a control system, and a sorting system. The automation equipment in unmanned sorting can quickly and accurately complete a sorting task, with high sorting speed and accuracy. Furthermore, by optimizing a layout of goods storage and sorting, a utilization rate of a warehouse space is increased, and a warehouse occupation area is reduced. A data management system can record detailed information and sorting processes of goods, which facilitates goods traceability and quality control. An identification system and a control system are almost mature, but a sorting system requires to be selected according to different requirements.

At present, common types of sorter on the market include tiltable tray sorter, slider sorter, and carbel sorter. The slider sorter means that a slider that can laterally slide is arranged on a sliding plate of a conveyor. When goods arrive at a designated position, the slider pushes the goods to slide towards corresponding goods outlets. The carbel sorter is a sorting system composed of a series of small belt conveyors. Goods are placed on cross belts. By being controlled through a computer, the cross belts can accurately convey the goods to a designated goods outlet.

During sorting of warehouse goods, the main method is the tiltable tray sorting. The tiltable tray sorter can be simply understood as placing goods on a tiltable tray. The tiltable tray can be tilted according to an instruction of a control system to pour the goods into a designated goods outlet or conveyor line. The common tiltable tray sorter is one-way deflection sorter, which can only sort goods with the same information. However, in the one-way sorting, goods are easily stacked at one outlet, which can lead to blockage of the outlet.

Therefore, it is required to provide an unmanned warehouse-goods sorting operation device to solve the above technical problems.

### SUMMARY

The present disclosure aims to overcome the shortcomings in the prior art, and provides an unmanned warehouse-goods sorting operation device.

The unmanned warehouse-goods sorting operation device includes a goods feeding conveyor, a tiltable tray assembly, and a goods discharging conveyor which are arranged in sequence in a longitudinal direction, wherein the tiltable tray assembly is configured to perform bidirectional sorting on goods in a lateral direction;
the tiltable tray assembly includes a tiltable tray part, two load-bearing shaft rods, and a support frame; the two load-bearing shaft rods are respectively arranged below two lateral sides of the tiltable tray part; the support frame is mounted between the two load-bearing shaft rods; the tiltable tray part is mounted at a top of a center of the support frame; when the load-bearing shaft rods rotate, the tiltable tray part is tilted laterally;
a surface of the tiltable tray part includes a conveyor belt laterally sleeving; a synchronous belt sleeves between the two load-bearing shaft rods; and the synchronous belt is pulled and connected to a bottom surface of the conveyor belt via a synchronous rope to control the conveyor belt to rotate.

In some embodiments, driving gears are arranged at two ends of each of the two load-bearing shaft rods; driving rods are arranged between the two load-bearing shaft rods; two ends of each of the driving rods are connected to driving racks; the driving racks are meshed with the driving gears, one of the driving rods is connected to a hydraulic push rod; and the hydraulic push rod is configured to: control the one driving rod to laterally translate and drive the two load-bearing shaft rods to rotate.

In some embodiments, a drum is rotatably mounted on each of the two load-bearing shaft rods; a gear plate and annular tooth blocks are arranged on each drum; the driving racks are fixedly connected with linkage racks; the linkage racks are meshed with the annular tooth blocks; and the synchronous belt sleeves the gear plate.

In some embodiments, a bottom of the synchronous belt is fixedly connected with a pallet; a bottom end of the synchronous rope is fixed on the pallet; and a top end of the synchronous rope is fixed at a bottom of the conveyor belt.

In some embodiments, balls are distributed on a surface of the conveyor belt.

A method for using the unmanned warehouse-goods sorting operation device includes the following steps:
Step I: in a goods conveying direction that is a longitudinal direction, mounting the goods feeding conveyor, the tiltable tray assembly, and the goods discharging conveyor in sequence, and laterally arranging the tiltable tray assembly; mounting a scanning module and a control system on the goods feeding conveyor; arranging sorting baskets for two types of goods on two lateral sides of the tiltable tray assembly respectively;
Step II: before the goods feeding conveyor conveys the goods to the tiltable tray assembly, distinguishing the types of goods by the scanning module; and
Step III: moving the goods onto the conveyor belt; when the goods are in one of the two types of goods, controlling, by the control system, the two load-bearing shaft rods and the synchronous belt to rotate, causing the tiltable tray part to tilt towards a lateral side and the synchronous rope to pull the conveyor belt to rotate, causing the goods to fall into the sorting basket from the lateral side of the tiltable tray part.

In some embodiments, the tiltable tray assembly and the goods discharging conveyor that are adjacent to each other form a sorting unit, and multiple sorting units are arranged in the unmanned warehouse-goods sorting operation device according to a quantity of types of goods to be distinguished.

Beneficial effects of the present disclosure are as follows:
1) According to the present disclosure, since at a top of the tiltable tray assembly, the tiltable tray part is included, the tiltable tray part can be controlled to deflect laterally to two sides through the load-bearing shaft rods. When a sorting operation is performed on warehouse goods, a deflection direction of the tiltable tray assembly can be changed by controlling the extension and contraction of the hydraulic push rod. When the tiltable tray part is tilted relative to a horizontal plane, the goods slide on the conveyor belt, thereby achieving a bidirectional deflection sorting effect of the tiltable tray part, meeting sorting requirements of goods with different information, and effectively avoiding a situation of goods stacking caused by one-way sorting.
2) According to the present disclosure, on the surface of the tiltable tray part, the conveyor belt laterally arranged is included. In a sorting operation, when the tiltable tray part deflects, the synchronous belt pulls the bottom surface of the conveyor belt to enable the bottom surface to synchronously rotate, so that the goods can automatically slide down along the deflected inclined surface, avoiding the situation that goods cannot be self-separated because of a large frictional force on surfaces of the goods. This further increases a separation speed of the goods. Furthermore, the active rotation mode can meet sorting requirements of different goods, and the applicability is broader.

### BRIEF DESCRIPTION OF THE DRAWINGS

FIG. 1 is a schematic diagram of an entire structure of the present disclosure;

FIG. 2 is a three-dimensional diagram I of a tiltable tray assembly according to the present disclosure;

FIG. 3 is a front view of a shaft bracket according to the present disclosure;

FIG. 4 is a partially enlarged view of region A in FIG. 2 according to the present disclosure;

FIG. 5 is a three-dimensional diagram II of a tiltable tray assembly according to the present disclosure;

FIG. 6 is a partially enlarged view of region B in FIG. 5 according to the present disclosure;

FIG. 7 is a partially enlarged view of region C in FIG. 5 according to the present disclosure;

FIG. 8 is a front view of a tiltable tray assembly according to the present disclosure; and

FIG. 9 is a sectional view of a drum according to the present disclosure.

Reference numerals in the drawings: goods feeding conveyor 1, goods discharging conveyor 2, tiltable tray assembly 3, mounting frame 4, scanning module 5, control system 6, support plate 31, shaft bracket 32, driving gear 33, support frame 34, tiltable tray part 35, rectangle block 36, centering block 37, external block 38, hydraulic push rod 39, side plate 351, rotating shaft 352, conveyor belt 353, internal slot 354, ball 355, lateral round slot 356, inner supporting round pipe 357, synchronous belt 320, load-bearing shaft rod 321, gear plate 322, synchronous belt 323, drum 324, annular tooth block 325, linkage rack 326, positioning disk 327, pallet 328, insertion hole 361, driving rod 362, driving rack 381, shaft sleeve 51, ejector pin 52, and steel ball 53.

### DETAILED DESCRIPTION OF THE EMBODIMENTS

The present disclosure will be further described below in conjunction with embodiments. The explanations of the following embodiments are merely used for helping understand the present disclosure. It should be pointed out that a person of ordinary skill in the art can also make several modifications to the present disclosure without departing from the principles of the present disclosure, and these improvements and modifications also fall within the scope of protection of the claims of the present disclosure.

### Embodiment I

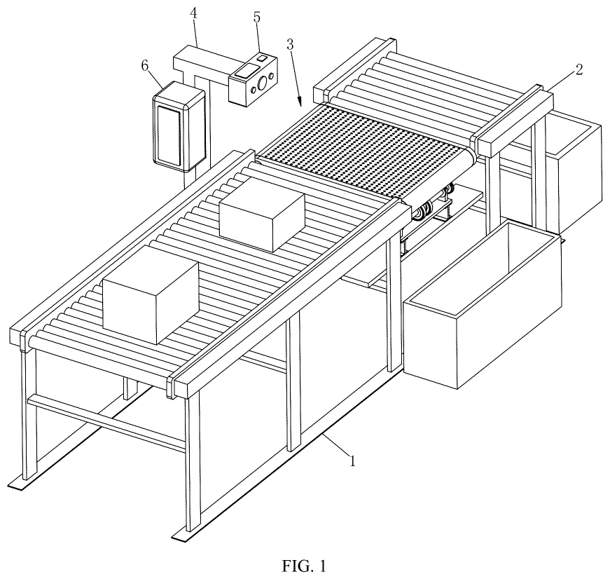

As an embodiment, as shown in FIG. 1, an unmanned warehouse-goods sorting operation device includes a goods feeding conveyor 1 and a goods discharging conveyor 2. The goods feeding conveyor 1 and the goods discharging conveyor 2 are arranged longitudinally along a straight line, and a tiltable tray assembly 3 is arranged in an arrangement gap between the goods feeding conveyor 1 and the goods discharging conveyor 2. The goods feeding conveyor 1 and the goods discharging conveyor 2 can automatically convey goods. The goods discharging conveyor 2 and the tiltable tray assembly 3 are combined into a sorting unit, and at least one sorting unit is arranged longitudinally in each unmanned warehouse-goods sorting operation device to perform bidirectional sorting on goods.

A mounting frame 4 is arranged on one side of each tiltable tray assembly 3. A scanning module 5 for identifying goods information is horizontally mounted at a top of the mounting frame 4. The scanning module 5 is mainly configured to scan and obtain the goods information. The information is not limited to destination, size, color, and the like. One sorting unit is taken as an example. A single tiltable tray assembly 3 can sort two different types of goods. Different types of goods are sorted to two sides of the tiltable tray assembly 3.

It is also possible to sort the same type of goods to two sides of the sorting unit, which effectively avoids a situation of goods accumulation caused by one-way sorting.

A control system 6 is mounted on an outer side wall of the mounting frame 4. The control system 6 includes a central processing module that receives and processes information identified by the scanning module 5, and a control module that controls the operations of the tiltable tray assembly 3. The information identified by the scanning module 5 is directly transmitted to the control system 6. The central processing module located in the control system 6 can compare the received information, transmit, when a sorting requirement is met, a signal to the control module, and send an instruction to notify the control module to drive the tiltable tray assembly 3 to operate, which achieves an unmanned sorting function. A specific operation procedure of this unmanned sorting system will not be elaborated. For details, refer to a common unmanned sorting system on the market.

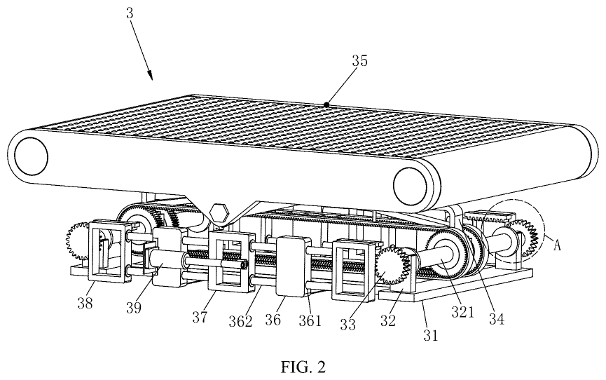

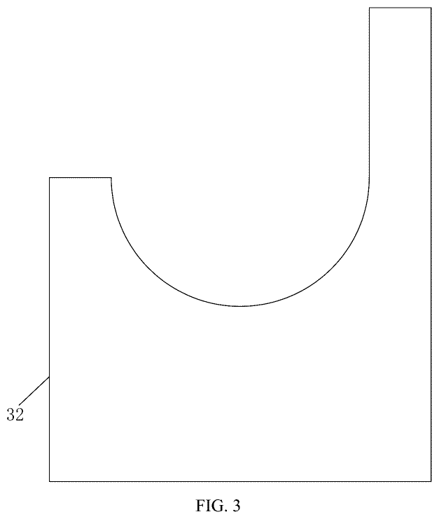

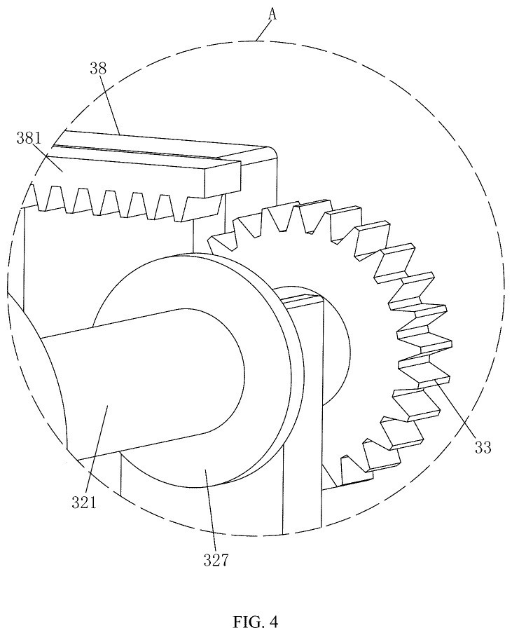

As shown in FIG. 2 to FIG. 4, the tiltable tray assembly 3 includes two support plates 31 fixedly connected to the goods feeding conveyor 1 and the goods discharging conveyor 2. Shaft brackets 32 are symmetrically welded at tops of the two parallel support plates 31, and a semi-circular slot is provided in a top of each shaft bracket 32. A height of an outer side of a top of each semi-circular slot is greater than a height of an inner side of the top of the each semi-circular slot. The load-bearing shaft rods 321 are placed inside the shaft brackets 32, and the two ends of each load-bearing shaft rod 321 are welded with driving gears 33 for being connected to a driving device to make each load-bearing shaft rod 321 rotate.

Positioning disks 327 are fixedly mounted on an outer wall of each load-bearing shaft rod 321. Two end surfaces of each positioning disk 327 are smooth surfaces. One end surface of each positioning disk 327 is in contact with a side wall of each shaft bracket 32 but not connected. By the contact between the shaft brackets 32 and the positioning disks 327, longitudinal displacements of the load-bearing shaft rods 321 can be limited to prevent longitudinal offsets of the load-bearing shaft rods 321.

Rectangle blocks 36 are symmetrically welded on two sides of each of the support plates 31. Insertion holes 361 are symmetrically provided in each of the rectangle blocks 36. Driving rods 362 are laterally inserted into the insertion holes 361. A centering block 37 and two external blocks 38 are respectively arranged between the two rectangle blocks 36 and at outer side positions of the two rectangle blocks on the same side. Side walls of the centering block 37 and side walls of the external blocks 38 are fixedly connected to the driving rod 362. Top side walls of the external blocks 38 are welded with driving racks 381, and the driving racks 381 are meshed with the driving gears 33. A hydraulic push rod 39 is mounted on a side wall of one of the rectangle blocks 36. An end of a piston rod of the hydraulic push rod 39 is connected to a side wall of one centering block 37 via a connecting rod.

A support frame 34 is fixedly mounted between the two load-bearing shaft rods 321, and a tiltable tray part 35 is mounted at a center position of a top of the support frame 34. The hydraulic push rod 39 horizontally drives the centering block 37, and the centering block 37 drives the two external blocks 38 on the same side to move synchronously through the driving rods 362. In this case, the driving racks 381 at one end move towards the driving gears 33 and are meshed with the driving gears, and the driving racks 381 at the other end gradually move away from the driving gears 33 on the same side. After the driving racks 381 are meshed with the driving gears 33 adjacent thereto, where the driving gears 33 can drive the load-bearing shaft rods 321 to rotate inside the shaft brackets 32. The tiltable tray part 35 is fixed to the load-bearing shaft rods 321 via the supporting frame 34. When the load-bearing shaft rods 321 rotate, the supporting frame 34 correspondingly rotates, causing the tiltable tray part 35 to rotate with the load-bearing shaft rods 321. Namely, the tiltable tray part 35 has oblique deflection laterally. A surface of the tiltable tray part 35 is smooth, so that goods easily slide from the tiltable tray part 35.

After the tiltable tray part 35 deflects an angle, goods at its top position can slide down under their gravities, achieving a sorting effect.

### Embodiment II

As another embodiment, Embodiment II provides more specific unmanned warehouse-goods sorting operation device based on Embodiment I. A conveyor belt 353 covers a surface of the tiltable tray part 35, and the conveyor belt 353 is driven by a synchronous rope 320.

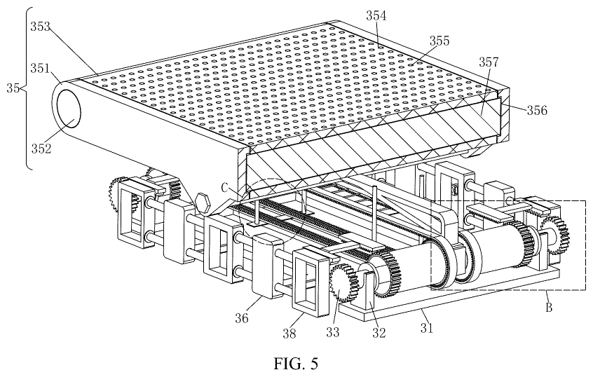

As shown in FIG. 5, the tiltable tray part 35 includes two side plates 351, rotating shafts 352, and the conveyor belt 353. The two side plates 351 are fixedly mounted on the support frame 34 via bolts. The rotating shafts 352 are symmetrically mounted at positions that are between the two side plates 351 and close to ends of the two side plates. The conveyor belt 353 sleeves outer walls of the two rotating shafts 352. The conveyor belt 353 is laterally arranged. Lateral round slots 356 are provided at equal spacing in inner walls of the side plates 351. An inner supporting round pipes 357 are horizontally placed between two lateral round slots 356 corresponding to the two side plates 351, and outer walls of the inner supporting round pipes 357 resist against an inner wall of the conveyor belt 353. The multiple inner supporting round pipes 357 are laterally arranged in a cavity inside the conveyor belt 353. When goods are located at a top of the conveyor belt 353, the conveyor belt 353 is unlikely to have inwards sunken deformation.

Internal slots 354 are provided in equal spacing in a surface of the conveyor belt 353 along a path direction. A ball 355 is mounted in any internal slot 354. A frictional force between the goods and the conveyor belt 353 is further reduced through the balls 355. A rotating speed of the conveyor belt 353 relative to the two rotating shafts 352 is determined according to the extension and contraction speed of the hydraulic push rod 39. In a normal state, a driving duration during which the hydraulic push rod 39 is restored from an extended state to an initial state may not be longer than 1.5 s, to meet a high-frequency sorting requirement.

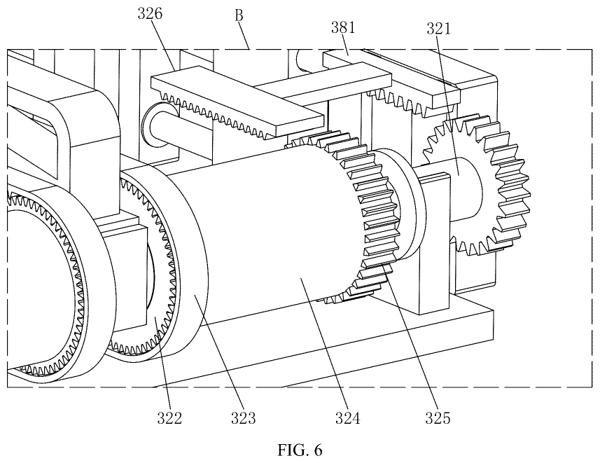

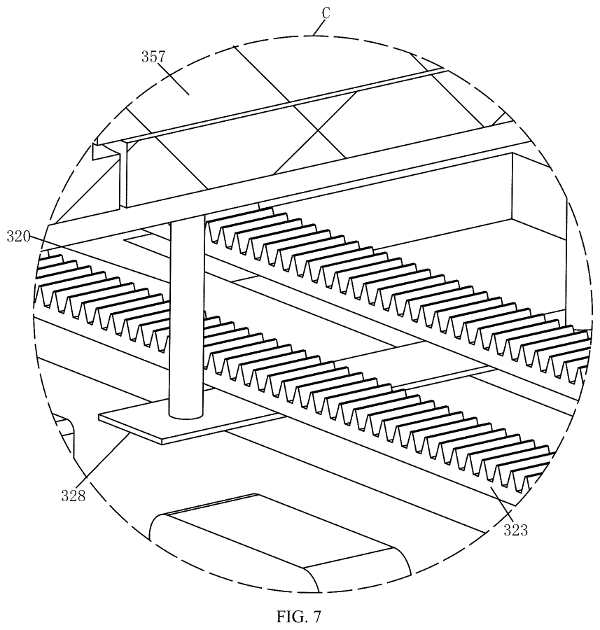

As shown in FIG. 6 and FIG. 7, gear plates 322 are symmetrically rotatably mounted on outer walls of the load-bearing shaft rods 321. A synchronous belt 323 is laterally mounted between two gear plates 322 in the same vertical plane of the two load-bearing shaft rods 321. A pallet 328 is fixedly mounted on a bottom end surface of the synchronous belt 323, and a synchronous rope 320 is embedded into an end surface at a top of the pallet 328. An end of the synchronous rope 320 is fixed at a bottom of the conveyor belt 353. Drums 324 are concentrically welded on side walls of the gear plates 322. Annular tooth blocks 325 are arranged on outer rings of the drums 324. A linkage rack 326 is fixedly mounted on one side of each driving rack 381 via a rectangle pipe, and the linkage racks 326 and the annular tooth blocks 325 are matched with each other. In the initial state, the linkage racks 326 are in no contact with the annular tooth blocks 325 until the hydraulic push rod 39 enters an operating state, so that the driving rod 362 translates towards the corresponding side.

There are multiple synchronous ropes 320 distributed at equal spacing along a surface of the synchronous belt 323. The multiple synchronous ropes 320 can simultaneously drive the synchronous belt 323 to move. Damage of a single synchronous belt 323 does not affect normal operation of the synchronous belt 323. An upper surface of the synchronous belt 323 is parallel to upper and lower surfaces of the conveyor belt 353, namely, the synchronous ropes 320 can pull the synchronous belt 323 in a horizontal direction, to reduce deformation of the synchronous belt 323.

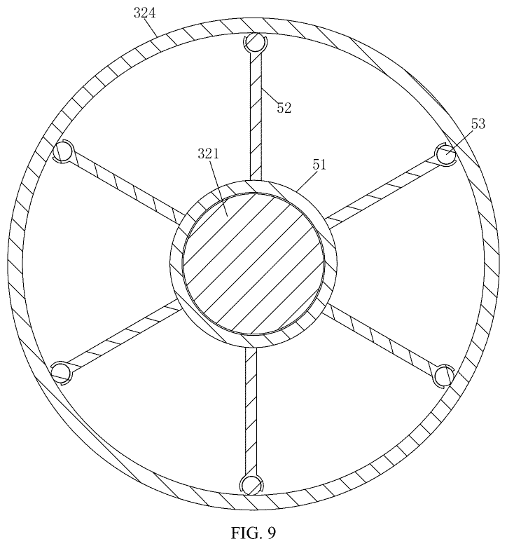

As shown in FIG. 9, a shaft sleeve 51 is mounted on each load-bearing shaft rod 321. Ejector pins 52 are welded in equal spacing on an outer wall of the shaft sleeve 51 in a circumferential direction. Steel balls 53 are embedded into ends of the ejector pins 52, and outer walls of the steel balls 53 resist against an inner wall of the drum 324. When the load-bearing shaft rods 321 deflect, the shaft sleeves 51 rotate relative to the load-bearing shaft rods 321. The axial positions of the shaft sleeves 51 relative to the load-bearing shaft rods 321 remain unchanged. The steel balls 53 at the tops of the ejector pins 52 roll along the inner wall of the drum 324 to support inside of the drum 324, which can prevent deformation of the drum 324.

It should be noted that identical or similar parts in this embodiment and Embodiment I can be referred to each other. The present disclosure will not elaborate this.

### Embodiment III

As another embodiment, Embodiment III provides a method for using the unmanned warehouse-goods sorting operation device based on Embodiment I and Embodiment II:
Step I: in a goods conveying direction that is a longitudinal direction, the goods feeding conveyor 1, the tiltable tray assembly 3, and the goods discharging conveyor 2 are mounted in sequence, and the tiltable tray assembly 3 is laterally arranged; he scanning module 5 and the control system 6 are mounted on the goods feeding conveyor 1; sorting baskets for two types of goods are respectively arranged on two lateral sides of the tiltable tray assembly 3. The tiltable tray assembly 3 and the goods discharging conveyor 2 that are adjacent to each other form one sorting unit. Multiple sorting units are arranged in the sorting operation device according to a quantity of goods types to be distinguished.
Step II: before the goods feeding conveyor 1 conveys goods to the tiltable tray assembly 3, the types of goods are distinguished by the scanning module 5. When the goods are in one of the two types of goods corresponding to the sorting unit, a conveying speed of the goods feeding conveyor 1 is reduced, causing the goods to gradually slow down and stop after the goods reach a position above the tiltable tray part 35. Then, step III is performed.
Step III: the load-bearing shaft rods 321 and the synchronous belts 323 are controlled to rotate by the control system 6, so that the tiltable tray part 35 tilts towards one lateral side.

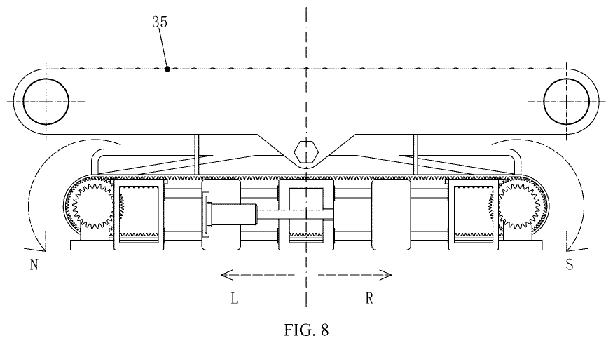

As shown in FIG. 8, in this embodiment, the driving rods 362 moving to the left, namely, in an L direction is taken as an example. The end of tiltable tray part 35 in the L direction drops, and the end of tiltable tray part 35 in an R direction rises. The driving gears 33 have equal rotation angles at any time. The rotation angles of the driving gears 33 are determined by extension and contraction of the hydraulic push rod 39. The extension and contraction of the hydraulic push rod 39 can be precisely controlled by the control system 6. After the tiltable tray part 35 deflects an angle, the goods at its top position can slide down under their gravities, achieving a sorting effect. The active rotation mode can meet requirements for sorting goods with different shapes and different friction coefficients. The applicability is broader.

The driving racks 381 on the external blocks 38 on the two sides make the driving gears 33 rotate, thus driving the two load-bearing shaft rods 321 to rotate in an N direction, while the drum 324 also rotates in the N direction, and the bottom of the synchronous belt 323 moves in the R direction to drive the pallet 328 and bottom ends of the synchronous ropes 320 to move in the R direction, so that the conveyor belt 353 moves in the R direction around a portion of a bottom surface of the tiltable tray part 35, and the conveyor belt 353 at the top of the tiltable tray part 35 moves in the L direction. The goods on the tiltable tray assembly 3 slide down in the L direction from the position above the middle of the tiltable tray part 35 and fall into the sorting basket.

When the goods do not belong to the two types corresponding to the sorting unit, which means that the goods are not identified by the scanning module 5, the conveying speed of the goods feeding conveyor 1 does not decrease, but increases, so that after the goods move from the goods feeding conveyor 1 onto the tiltable tray assembly 3, since the surface of the conveyor belt 353 is smooth and horizontal and is provided with the balls 355, the goods further move longitudinally to directly slide to a position above the goods discharging conveyor 2 and are conveyed to a farther place, for sorting by a subsequent sorting unit or for direct discharging.

The various embodiments in this specification are described in a progressive manner, and each embodiment focuses on differences from other embodiments. The same or similar parts between all the embodiments can be referred to each other.

What is claimed is:

1. An unmanned warehouse-goods sorting operation device, comprising a goods feeding conveyor, a tiltable tray assembly, and a goods discharging conveyor which are arranged in sequence in a longitudinal direction, wherein the tiltable tray assembly is configured to perform bidirectional sorting on goods in a lateral direction;
the tiltable tray assembly comprises a tiltable tray part, two load-bearing shaft rods, and a support frame; the two load-bearing shaft rods are respectively arranged below two lateral sides of the tiltable tray part; the support frame is mounted between the two load-bearing shaft rods; the tiltable tray part is mounted at a top of a center of the support frame; when the load-bearing shaft rods rotate, the tiltable tray part is tilted laterally;
a surface of the tiltable tray part comprises a conveyor belt laterally sleeving; a synchronous belt sleeves and is disposed between the two load-bearing shaft rods; and the synchronous belt is pulled and connected to a bottom surface of the conveyor belt via a synchronous rope, to control the conveyor belt to rotate.

2. The unmanned warehouse-goods sorting operation device according to claim 1, wherein driving gears are arranged at two ends of each of the two load-bearing shaft rods; driving rods are arranged between the two load-bearing shaft rods; two ends of each of the driving rods are connected to driving racks; the driving racks are meshed with the driving gears, one of the driving rods is connected to a hydraulic push rod; and the hydraulic push rod is configured to: control the one driving rod to laterally translate and drive the two load-bearing shaft rods to rotate.

3. The unmanned warehouse-goods sorting operation device according to claim 2, wherein a drum is rotatably mounted on each of the two load-bearing shaft rods; a gear plate and annular tooth blocks are arranged on each drum; the driving racks are fixedly connected with linkage racks; the linkage racks are meshed with the annular tooth blocks; and the synchronous belt sleeves the gear plate.

4. The unmanned warehouse-goods sorting operation device according to claim 1, wherein a bottom of the synchronous belt is fixedly connected with a pallet; a bottom end of the synchronous rope is fixed on the pallet; and a top end of the synchronous rope is fixed at a bottom of the conveyor belt.

5. The unmanned warehouse-goods sorting operation device according to claim 1, wherein balls are distributed on a surface of the conveyor belt.

6. A method for using the unmanned warehouse-goods sorting operation device according to claim 1, comprising:
in a goods conveying direction that is a longitudinal direction, mounting the goods feeding conveyor, the tiltable tray assembly, and the goods discharging conveyor in sequence, and laterally arranging the tiltable tray assembly; mounting a scanning module and a control system on the goods feeding conveyor; arranging sorting baskets for two types of goods on two lateral sides of the tiltable tray assembly respectively;
before the goods feeding conveyor conveys the goods to the tiltable tray assembly, distinguishing the types of goods by the scanning module; and
moving the goods onto the conveyor belt; when the goods are in one of the two types of goods, controlling, by the control system, the two load-bearing shaft rods and the synchronous belt to rotate, causing the tiltable tray part to tilt towards a lateral side and the synchronous rope to pull the conveyor belt to rotate, causing the goods to fall into the sorting basket from the lateral side of the tiltable tray part.

7. The method for using the unmanned warehouse-goods sorting operation device according to claim 6, wherein the tiltable tray assembly and the goods discharging conveyor that are adjacent to each other form a sorting unit, and a plurality of sorting units are arranged in the unmanned warehouse-goods sorting operation device according to a quantity of types of goods to be distinguished.

8. The method for using the unmanned warehouse-goods sorting operation device according to claim 6, wherein driving gears are arranged at two ends of each of the two load-bearing shaft rods; driving rods are arranged between the two load-bearing shaft rods; two ends of each of the driving rods are connected to driving racks; the driving racks are meshed with the driving gears, one of the driving rods is connected to a hydraulic push rod; and the hydraulic push rod is configured to: control the one driving rod to laterally translate and drive the two load-bearing shaft rods to rotate.

9. The method for using the unmanned warehouse-goods sorting operation device according to claim 8, wherein a drum is rotatably mounted on each of the two load-bearing shaft rods; a gear plate and annular tooth blocks are arranged on each drum; the driving racks are fixedly connected with linkage racks; the linkage racks are meshed with the annular tooth blocks; and the synchronous belt sleeves the gear plate.

10. The method for using the unmanned warehouse-goods sorting operation device according to claim 6, wherein a bottom of the synchronous belt is fixedly connected with a pallet; a bottom end of the synchronous rope is fixed on the pallet; and a top end of the synchronous rope is fixed at a bottom of the conveyor belt.

11. The method for using the unmanned warehouse-goods sorting operation device according to claim 6, wherein balls are distributed on a surface of the conveyor belt.

12. The method for using the unmanned warehouse-goods sorting operation device according to claim 8, wherein the tiltable tray assembly and the goods discharging conveyor that are adjacent to each other form a sorting unit, and a plurality of sorting units are arranged in the unmanned warehouse-goods sorting operation device according to a quantity of types of goods to be distinguished.

13. The method for using the unmanned warehouse-goods sorting operation device according to claim 9, wherein the tiltable tray assembly and the goods discharging conveyor that are adjacent to each other form a sorting unit, and a plurality of sorting units are arranged in the unmanned warehouse-goods sorting operation device according to a quantity of types of goods to be distinguished.

14. The method for using the unmanned warehouse-goods sorting operation device according to claim 10, wherein the tiltable tray assembly and the goods discharging conveyor that are adjacent to each other form a sorting unit, and a plurality of sorting units are arranged in the unmanned warehouse-goods sorting operation device according to a quantity of types of goods to be distinguished.

15. The method for using the unmanned warehouse-goods sorting operation device according to claim 11, wherein the tiltable tray assembly and the goods discharging conveyor that are adjacent to each other form a sorting unit, and a plurality of sorting units are arranged in the unmanned warehouse-goods sorting operation device according to a quantity of types of goods to be distinguished.
